(19) United States
(12) Patent Application Publication
(10) Pub. No.: US 2025/0308007 A1
(43) Pub. Date: Oct. 2, 2025

(54) ELECTRONIC DEVICE AND IMAGE PROCESSING METHOD THEREOF

(71) Applicant: Samsung Electronics Co., Ltd., Suwon-si (KR)

(72) Inventors: Beomjoon KIM, Suwon-si (KR); Guiwon Seo, Suwon-si (KR); Jonghwan Kim, Suwon-si (KR)

(73) Assignee: Samsung Electronics Co., Ltd., Suwon-si (KR)

(21) Appl. No.: 19/237,864

(22) Filed: Jun. 13, 2025

Related U.S. Application Data
(63) Continuation of application No. PCT/KR2023/019369, filed on Nov. 28, 2023.

(30) Foreign Application Priority Data
Jan. 16, 2023 (KR) 10-2023-0006261

(51) Int. Cl. G06T 5/94; G06T 5/60; G06T 7/00; G06T 7/90

(52) U.S. Cl. CPC G06T 5/94; G06T 5/60; G06T 7/0002; G06T 7/90; G06T 2207/10024

(57) ABSTRACT

An electronic device includes memory and one or more processors. The electronic device obtains a plurality of candidate enhancement images by applying each contrast enhancement curve of the plurality of contrast enhancement curves to an input image, compares the plurality of candidate enhancement images with the input image and identify image variance information and enhancement effect information corresponding to each candidate enhancement image of the plurality of candidate enhancement images, identifies a final enhancement image from among the plurality of candidate enhancement images based on the image variance information and the enhancement effect information corresponding to each candidate image, and obtains an output image corresponding to the input image based on the identified final enhancement image.

### CROSS-REFERENCE TO RELATED APPLICATIONS

This application is a continuation application of International Application No. PCT/KR2023/019369, filed on Nov. 28, 2023, which claims priority to Korean Patent Application No. 10-2023-0006261, filed on Jan. 16, 2023, in the Korean Intellectual Property Office, the disclosures of which are incorporated by reference herein in their entireties.

### BACKGROUND

### 1. Field

The disclosure relates to an electronic device and an image processing method thereof, and more particularly, to an electronic device capable of performing contrast enhancement processing for an input image and an image processing method thereof.

### 2. Description of Related Art

Electronic devices of various types are being developed and supplied due to developments in electronic technology. Specifically, development and supply of display devices such as televisions (TVs) or mobile devices are being actively carried out.

In order to provide users with images of a better image quality, various contrast enhancement methods are being researched.

### SUMMARY

According to an aspect of the disclosure, there is provided an electronic device, including memory storing at least one instruction and a plurality of contrast enhancement curves; and one or more processors operatively connected with the memory, wherein the at least one instruction, when executed by the one or more processors individually or collectively, causes the electronic device to: obtain a plurality of candidate enhancement images by applying each contrast enhancement curve of the plurality of contrast enhancement curves to an input image; compare the plurality of candidate enhancement images with the input image and identify image variance information and enhancement effect information corresponding to each candidate enhancement image of the plurality of candidate enhancement images; identify a final enhancement image from among the plurality of candidate enhancement images based on the image variance information and the enhancement effect information corresponding to each candidate image; and obtain an output image corresponding to the input image based on the identified final enhancement image.

The at least one instruction, when executed by the one or more processors individually or collectively, may cause the electronic device to: identify a pixel structure variance, a noise level variance, and a color variance corresponding to each candidate enhancement image by comparing each candidate enhancement image with the input image; and obtain the image variance information corresponding to each candidate enhancement image based on the pixel structure variance, the noise level variance, and the color variance.

The at least one instruction, when executed by the one or more processors individually or collectively, may cause the electronic device to: identify uniform pixel distribution information corresponding to each candidate enhancement image; and obtain the enhancement effect information corresponding to each candidate enhancement image based on the uniform pixel distribution information.

The at least one instruction, when executed by the one or more processors individually or collectively, may cause the electronic device to: obtain image variance values by applying pre-set weight values corresponding to each of the pixel structure variance, the noise level variance, and the color variance; and obtain the image variance information by normalizing after inversely converting the image variance values.

The at least one instruction, when executed by the one or more processors individually or collectively, may cause the electronic device to: obtain effect identification values based on histogram information corresponding to each candidate enhancement image; obtain the enhancement effect information by normalizing the effect identification values; identify final identification values corresponding to each candidate enhancement image by applying the pre-set weight values to the image variance information and the enhancement effect information; and identify the final enhancement image based on the identified final identification values.

The electronic device may include a display, wherein the at least one instruction, when executed by the one or more processors individually or collectively, may cause the electronic device to display the output image through the display, and wherein the pre-set weight values are identified differently according to a panel characteristic of the display.

The at least one instruction, when executed by the one or more processors individually or collectively, may cause the electronic device to identify, as the final enhancement image, an image with a small image variance value according to the image variance information and a large enhancement effect value according to the enhancement effect information from among the plurality of candidate enhancement images.

The at least one instruction, when executed by the one or more processors individually or collectively, may cause the electronic device to: obtain feature information from the input image; obtain the contrast enhancement curve corresponding to the input image from among the plurality of contrast enhancement curves by inputting the obtained feature information in a trained first artificial intelligence model; and obtain the output image by processing the input image based on the obtained contrast enhancement curve, wherein the trained first artificial intelligence model is trained to output, based on the feature information of an image being input, information about one contrast enhancement curve from among the plurality of contrast enhancement curves based on the image variance information and the enhancement effect information corresponding to the plurality of contrast enhancement curves of the image.

The at least one instruction, when executed by the one or more processors individually or collectively, may cause the electronic device to: obtain feature information from the input image; obtain the image variance information and the enhancement effect information corresponding to the plurality of candidate enhancement images by inputting the obtained feature information in a trained second artificial intelligence model; and identify the final enhancement image from among the plurality of candidate enhancement images based on the image variance information and the enhancement effect information corresponding to each candidate enhancement image, wherein the trained second artificial intelligence model is trained to output, based on the feature information of an image being input, the image variance information and the enhancement effect information corresponding to the plurality of candidate enhancement images obtained by applying the plurality of contrast enhancement curves to the image.

The at least one instruction, when executed by the one or more processors individually or collectively, may cause the electronic device to obtain the output image by inputting the input image in a trained third artificial intelligence model, wherein the trained third artificial intelligence model is trained to identify, based on an image being input, the image variance information and the enhancement effect information corresponding to the plurality of candidate enhancement images obtained by applying the plurality of contrast enhancement curves to the image, and output by identifying the final enhancement image from among the plurality of candidate enhancement images based on the identified image variance information and the identified enhancement effect information.

According to an aspect of the disclosure, there is provided an image processing method of an electronic device, the image processing method including: obtaining a plurality of candidate enhancement images by applying each contrast enhancement curve of a plurality of contrast enhancement curves to an input image; comparing the plurality of candidate enhancement images with the input image and identifying image variance information and enhancement effect information corresponding to each candidate enhancement image of the plurality of candidate enhancement images; identifying a final enhancement image from among the plurality of candidate enhancement images based on the image variance information and the enhancement effect information corresponding to each candidate enhancement image; and obtaining an output image corresponding to the input image based on the identified final enhancement image.

The identifying the image variance information and the enhancement effect information may include identifying a pixel structure variance, a noise level variance, and a color variance corresponding to each candidate enhancement image by comparing each candidate enhancement image with the input image; and obtaining the image variance information corresponding to each candidate enhancement image based on the pixel structure variance, the noise level variance, and the color variance.

The identifying the image variance information and the enhancement effect information may include: identifying uniform pixel distribution information corresponding to each candidate enhancement image; and obtaining the enhancement effect information corresponding to each candidate enhancement image based on the uniform pixel distribution information.

The obtaining the image variance information may include: obtaining image variance values by applying pre-set weight values corresponding to each of the pixel structure variance, the noise level variance, and the color variance; and obtaining the image variance information by normalizing after inversely converting the image variance values.

According to an aspect of the disclosure, there is provided a non-transitory computer-readable medium which stores computer instructions for an electronic device to perform an operation when executed by one or more processors of the electronic device, the operation including: obtaining a plurality of candidate enhancement images by applying each contrast enhancement curve of a plurality of contrast enhancement curves to an input image; comparing the plurality of candidate enhancement images with the input image and identifying image variance information and enhancement effect information corresponding to each candidate enhancement image of the plurality of candidate enhancement images; identifying a final enhancement image from among the plurality of candidate enhancement images based on the image variance information and the enhancement effect information corresponding to each candidate enhancement image; and obtaining an output image corresponding to the input image based on the identified final enhancement image.

### BRIEF DESCRIPTION OF THE DRAWINGS

The above and other aspects, features, and advantages of embodiments of the present disclosure will be more apparent from the following description taken in conjunction with the accompanying drawings, in which:

FIG. 1 is a diagram illustrating a working example of an electronic device according to an embodiment of the disclosure;

FIG. 2A is a block diagram illustrating a configuration of an electronic device according to an embodiment;

FIG. 2B is a block diagram illustrating a detailed configuration of a display device according to an embodiment;

FIG. 3 is a flowchart illustrating an image processing method of an electronic device according to an embodiment;

FIG. 4 is a diagram illustrating a configuration of function modules for performing an image processing method according to an embodiment;

FIG. 5 is a flowchart illustrating a method for predicting image variance information and enhancement effect information according to an embodiment;

FIG. 6A and FIG. 6B are diagrams illustrating an image processing method according to an embodiment;

FIG. 7A and FIG. 7B are diagrams illustrating an image processing method which uses a trained artificial intelligence model according to an embodiment;

FIG. 8 is a diagram illustrating an image processing method which uses a trained artificial intelligence model according to an embodiment;

FIG. 9 is a diagram illustrating an image processing method which uses a trained artificial intelligence model according to an embodiment; and

FIG. 10 is a diagram illustrating an image processing method which uses a trained artificial intelligence model according to an embodiment.

### DETAILED DESCRIPTION

The disclosure will be described in detail below with reference to the accompanying drawings.

Terms used in the disclosure will be briefly described, and the disclosure will be described in detail.

The terms used in describing the embodiments of the disclosure are general terms selected that are currently widely used considering their function herein. However, the terms may change depending on intention, legal or technical interpretation, emergence of new technologies, and the like of those skilled in the related art. Further, in certain cases, there may be terms arbitrarily selected, and in this case, the meaning of the term will be disclosed in greater detail in the corresponding description. Accordingly, the terms used herein are not to be understood simply as its designation but based on the meaning of the term and the overall context of the disclosure.

In the disclosure, expressions such as “have”, “may have”, “include”, and “may include” are used to designate a presence of a corresponding characteristic (e.g., elements such as numerical value, function, operation, or component), and not to preclude a presence or a possibility of additional characteristics.

The expression “at least one of A or B” is to be understood as indicating any one of “A,” “B,” or “A and B”.

Expressions such as “1st”, “2nd”, “first”, or “second” used in the disclosure may limit various elements regardless of order and/or importance, and may be used merely to distinguish one element from another element and not limit the relevant element.

When a certain element (e.g., a first element) is indicated as being “(operatively or communicatively) coupled with/to” or “connected to” another element (e.g., a second element), it may be understood as the certain element being directly coupled with/to the another element or as being coupled through other element (e.g., a third element).

A singular expression includes a plural expression, unless otherwise specified. It is to be understood that the terms such as “configured” or “include” are used herein to designate a presence of a characteristic, number, step, operation, element, component, or a combination thereof, and not to preclude a presence or a possibility of adding one or more of other characteristics, numbers, steps, operations, elements, components or a combination thereof.

The term “module” or “part” used herein perform at least one function or operation, and may be implemented with a hardware or software, or implemented with a combination of hardware and software. In addition, a plurality of “modules” or a plurality of “parts,” except for a “module” or a “part” which needs to be implemented with a specific hardware, may be integrated in at least one module and implemented as at least one processor.

An embodiment of the disclosure will be described in greater detail below with reference to the accompanying drawings.

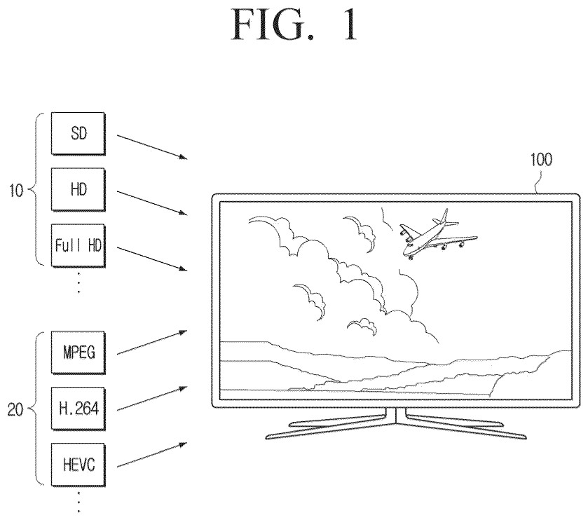

FIG. 1 is a diagram illustrating a working example of an electronic device according to an embodiment of the disclosure.

An electronic device 100 may be implemented as a television (TV) or a set-top box as shown in FIG. 1, but is not limited thereto, and may be applicable to any device without limitation so long as an image processing and/or a display function is included such as, for example, and without limitation, a smartphone, a tablet personal computer (PC), a notebook PC, a head mounted display (HMD), a near eye display (NED), a large format display (LFD), a digital signage, a digital information display (DID), a video wall, a projector display, a camera, a camcorder, a printer, and the like.

The electronic device 100 may receive various compressed images or images of various resolutions. For example, the electronic device 100 may receive images in a compressed form such as, for example, and without limitation, a moving picture experts group (MPEG)(e.g., MP2, MP4, MP7, etc.), a joint photographic coding experts group (JPEG), an advanced video coding (AVC), H.264, H.265, a high efficiency video codec (HEVC), and the like. Alternatively, the electronic device 100 may receive any one image from among images of a standard definition (SD), a high definition (HD), a full HD, an ultra HD, or images of a higher resolution.

Contrast ratio enhancement is a low-level image processing technique that clarifies a difference of a dark region and a bright region of an image, and improves image quality by making clear a region of interest within the image or redistributing contrast values. The contrast ratio enhancement is used to provide a clear image to a human eye through image quality improvement or as a pre-processing step for processing a high-level image in an image system.

A method for designing a tone mapping curve with which a tone in an existing image is adjusted may design a curve with which a histogram may be distributed taking into consideration pixel distribution of an image and obtain an image with improved contrast ratio. However, image characteristics that are considered in a method of the related art is limited to a portion of the characteristics such as a pixel distribution histogram, and there is a possibility of having a contrast enhancement effect in some images but a side effect occurring in other images. Specifically, an excessive application of the tone mapping curve may reduce visibility by damaging information of an image.

Accordingly, identifying information loss and/or side effects (noise emphasis, color change) of an image which occurs due to excessive contrast ratio together with the contrast enhancement effect may be identified and various embodiments implementing an optimized contrast processing based therefrom will be described below.

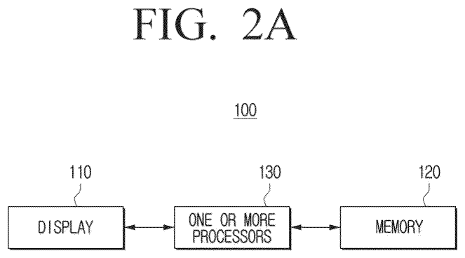

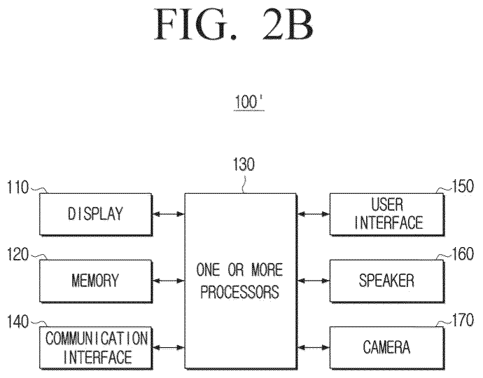

FIG. 2A is a block diagram illustrating a configuration of an electronic device according to an embodiment.

Referring to FIG. 2A, the electronic device 100 may include a display 110, memory 120, and one or more processors 130.

The display 110 may be implemented as a display including self-emissive devices or a display including non-emissive devices and a backlight. For example, the display 110 may be implemented as a display of various types such as, for example, and without limitation, a liquid crystal display (LCD), an organic light emitting diode (OLED) display, a light emitting diode (LED) display, a micro LED display, a mini LED display, a plasma display panel (PDP), a quantum dot (QD) display, a quantum dot light emitting diodes (QLED) display, or the like. In the display 110, a driving circuit, which may be implemented in a form of an a-si TFT, a low temperature poly silicon (LTPS) TFT, an organic TFT (OTFT), or the like, a backlight unit, and the like may be included. According to an example, the display 110 may be implemented as a flat display, a curved display, a foldable and/or a rollable flexible display, or the like.

The memory 120 may store data necessary for various embodiments. The memory 120 may be implemented in a form of a memory embedded in an electronic device 100′ according to a data storage use, or implemented in a form of a memory attachable to or detachable from the electronic device 100. For example, data for the driving of the electronic device 100 may be stored in the memory embedded in the electronic device 100′, and data for an expansion function of the electronic device 100 may be stored in the memory attachable to or detachable from the electronic device 100. The memory embedded in the electronic device 100′ may be implemented as one or more from among a volatile memory (e.g., a dynamic RAM (DRAM), a static RAM (SRAM), a synchronous dynamic RAM (SDRAM), or the like), or a non-volatile memory (e.g., a one time programmable ROM (OTPROM), a programmable ROM (PROM), an erasable and programmable ROM (EPROM), an electrically erasable and programmable ROM (EEPROM), a mask ROM, a flash ROM, a flash memory (e.g., NAND flash or NOR flash), a hard disk drive (HDD) or a solid state drive (SSD)). In addition, the memory attachable to or detachable from the electronic device 100 may be implemented in a form such as, for example, and without limitation, a memory card (e.g., a compact flash (CF), a secure digital (SD), a micro secure digital (micro-SD), a mini secure digital (mini-SD), an extreme digital (xD), a multi-media card (MMC), etc.), an external memory (e.g., USB memory) connectable to a USB port, or the like.

According to an example, the memory 120 may store a plurality of contrast enhancement curves. For example, a contrast enhancement curve may be implemented as the tone mapping curve. Here, tone mapping may be a method of representing an original tone of an image to match a dynamic range of the display 110, and may provide optimized colors by optimizing contrast.

The one or more processors 130 may control an overall operation of the electronic device 100. Specifically, the one or more processors 130 may control the overall operation of the electronic device 100 by being connected with each configuration of the electronic device 100. For example, the one or more processors 130 may control the overall operation of the electronic device 100 by being electrically connected with the display 110 and the memory 120. The one or more processors 130 may be configured with one or a plurality of processors.

The one or more processors 130 may perform an operation of the electronic device 100 according to various embodiments by executing at least one instruction stored in the memory 120.

A function associated with artificial intelligence according to the disclosure may be operated through the processor and the memory of the electronic device.

The one or more processors 130 may be configured as one or a plurality of processors. At this time, the one or plurality of processors may include at least one from among a central processing unit (CPU), a graphic processing unit (GPU), and a neural processing unit (NPU), but is not limited by the examples of the above-described processor.

The CPU may be a generic-purpose processor which can perform not only general operations, but also artificial intelligence operations, and may efficiently execute complex programs through a multi-tiered cache structure. The CPU may be advantageous in a series processing method which allows for an organic connection between a previous calculation result and a following calculation result to be possible through a sequential calculation. The generic-purpose processor may not be limited to the above-described example except for when specified as the above-described CPU.

The GPU may be a processor for mass operations such as a floating point operation used in graphics processing, and perform a large-scale operation by integrating cores in mass in parallel. Specifically, the GPU may be advantageous in a parallel processing method such as a convolution operation compared to the CPU. In addition, the GPU may be used as a co-processor for supplementing a function of the CPU. The processor for mass operations may not be limited to the above-described example except for when specified as the above-described GPU.

The NPU may be a processor which specializes in an artificial intelligence operation using an artificial neural network, and may implement each layer that forms the artificial neural network with hardware (e.g., silicon). At this time, because the NPU is designed specialized according to a required specification of a company, there is a lower degree of freedom compared to the CPU or the GPU, but the NPU may efficiently process the artificial intelligence operation demanded by the company. As a processor specializing in the artificial intelligence operation, the NPU may be implemented in various forms such as, for example, and without limitation, a tensor processing unit (TPU), an intelligence processing unit (IPU), a vision processing unit (VPU), and the like. The artificial intelligence processor may not be limited to the above-described example except for when specified as the above-described NPU.

In addition, the one or more processors 130 may be implemented as a System on Chip (SoC). At this time, the SoC may be further included with the memory 120 in addition to the one or more processors 130, and a network interface such as a Bus for data communication between the processor 130 and the memory 120.

If a plurality of processors are included in the System on Chip (SoC) included in the electronic device 100, the electronic device 100 may perform an operation associated with artificial intelligence (e.g., an operation associated with learning or inference of an artificial intelligence model) using a portion of the processors from among the plurality of processors. For example, the electronic device may perform an operation associated with artificial intelligence using at least one from among the GPU, the NPU, the VPU, the TPU, and a hardware accelerator specializing in artificial intelligence operations such as the convolution operation, and a matrix multiplication operation from among the plurality of processors. However, the above is merely one embodiment, and operations associated with artificial intelligence may be processed using the generic-purpose processor such as the CPU.

In addition, the electronic device 100 may perform an operation for a function associated with artificial intelligence by using multicores (e.g., a dual core, a quad core, etc.) included in one processor. Specifically, the electronic device may perform artificial intelligence operations such as the convolution operation and the matrix multiplication operation in parallel using the multicores included in the processor.

The one or more processors 130 may control to process input data according to a pre-defined operation rule or an artificial intelligence model stored in the memory 120. The pre-defined operation rule or the artificial intelligence model are characterized by being created through learning.

Here, the being created through learning may mean a pre-defined operation rule or an artificial intelligence model of a desired characteristic being created by applying a learning algorithm to a plurality of training data. The learning may be carried out in a device itself in which the artificial intelligence according to the disclosure is performed, or carried out through a separate server/system.

The artificial intelligence model may be configured with a plurality of neural network layers. At least one layer may have at least one weight value, and perform a layer operation through an operation result of a previous layer and at least one defined operation. Examples of the neural network may include a Convolutional Neural Network (CNN), a Deep Neural Network (DNN), a Recurrent Neural Network (RNN), a Restricted Boltzmann Machine (RBM), a Deep Belief Network (DBN), a Bidirectional Recurrent Deep Neural Network (BRDNN), a Deep-Q Networks, and a Transformer, and the neural network in the disclosure may not be limited to the above-described examples except for when specified.

The learning algorithm may be a method for training a predetermined target machine (e.g., robot) to make decisions or identifications on its own using the plurality of training data. Examples of the learning algorithm may include a supervised learning, an unsupervised learning, a semi-supervised learning, or a reinforcement learning, and the learning algorithm of the disclosure is not limited to the above-described examples unless otherwise specified. For convenience of description, the one or more processors 130 may be referred to as the processor 130 below.

FIG. 2B is a block diagram illustrating a detailed configuration of a display device according to an embodiment.

Referring to FIG. 2B, the electronic device 100′ may include the display 110, the memory 120, the one or more processors 130, a communication interface 140, a user interface 150, a speaker 160, and a camera 170. Detailed descriptions of configurations that overlap with the configurations shown in FIG. 2A from among the configurations shown in FIG. 2B will be omitted.

The communication interface 140 may support various communication methods according to a working example of the electronic device 100′. For example, the communication interface 140 may perform communication with an external device, an external storage medium (e.g., a USB memory), an external server (e.g., a cloud server), and the like through communication methods such as, for example, and without limitation, Bluetooth, AP-based Wi-Fi (Wireless LAN network), ZigBee, a wired/wireless local area network (LAN), a wide area network (WAN), Ethernet, IEEE 1394, a High-Definition Multimedia Interface (HDMI), a Universal Serial Bus (USB), a Mobile High-Definition Link (MHL), Audio Engineering Society/European Broadcasting Union (AES/EBU), Optical, Coaxial, or the like.

The user interface 150 may be implemented with a device such as a button, a touch pad, a mouse and a keyboard, or implemented as a touch screen capable of performing the above-described display function and an operation input function together therewith. According to an embodiment, the user interface 150 may be implemented as a remote controller transceiver and receive remote control signals. The remote controller transceiver may receive remote control signals from an external remote control device through at least one communication method from among an infrared communication method, a Bluetooth communication method, or a Wi-Fi communication method, or receive remote control signals.

The speaker 160 may output sound signals. For example, the speaker 160 may output digital sound signals processed in the processor 130 by converting and amplifying to analog sound signals. For example, the speaker 160 may include at least one speaker unit capable of outputting at least one channel, a D/A converter, an audio amplifier, and the like. According to an example, the speaker 160 may be implemented to output various multi-channel sound signals. In this case, the processor 130 may control the speaker 160 to perform enhancement processing and output sound signals which are input to correspond to the enhancement processing of an input image.

The camera 170 may be turned-on according to a pre-set event and perform capturing. The camera 170 may convert the captured image to an electric signal and generate image data based on the converted signal. For example, a subject may be converted to an electric image signal through a semiconductor optical device (a charge coupled device (CCD)), and the image signal converted as described above may be signal processed after being amplified and converted to a digital signal.

In addition thereto, the electronic device 100′ may include a microphone, a sensor, a tuner, a demodulator, and the like according to a working example.

The microphone may be a configuration for receiving input of a user voice or other sounds and converting to audio data. However, according to another embodiment, the electronic device 100′ may receive the user voice input through an external device through the communication interface 140.

The sensor may include sensors of various types such as, for example, and without limitation, a touch sensor, a proximity sensor, an acceleration sensor, a geomagnetic sensor, a gyro sensor, a pressure sensor, a position sensor, an illuminance sensor, and the like.

The tuner may receive a radio frequency (RF) broadcast signal by tuning channels selected by a user or all pre-stored channels from among the RF broadcast signals received through an antenna.

The demodulator may receive and demodulate digital IF (DIF) signals converted in the tuner and perform channel decoding, and the like.

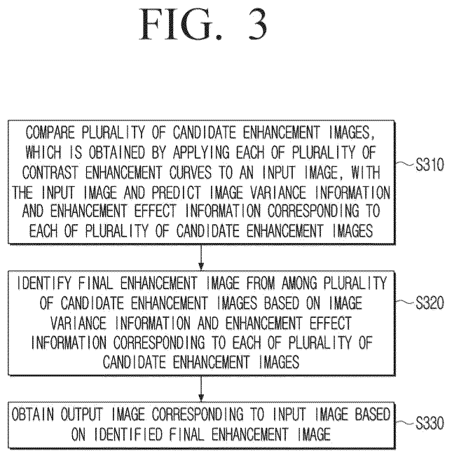

FIG. 3 is a flowchart illustrating an image processing method of an electronic device according to an embodiment.

According to an embodiment shown in FIG. 3, the processor 130 may compare a plurality of candidate enhancement images, which is obtained by applying each contrast enhancement curve of the plurality of contrast enhancement curves to an input image, with the input image and identify (or predict) image variance information (or excessiveness information) and contrast enhancement effect information (hereinafter, referred to as ‘enhancement effect information’) corresponding to each candidate enhancement image of the plurality of candidate enhancement images (S310). For example, the contrast enhancement curve may be implemented as the tone mapping curve, and if the tone mapping curve is an N-number, an N-number of candidate enhancement images may be obtained. However, if separate contrast enhancement curves are applied for each region, that is if a plurality of tone mapping curves is applied to one frame, candidate enhancement images may be obtained by a number of combined tone mapping curves.

Then, the processor 130 may identify a final enhancement image from among the plurality of candidate enhancement images based on the image variance information and the enhancement effect information corresponding to each of the plurality of candidate enhancement images (S320). According to an example, the processor 130 may identify an image with a small image variance value according to the image variance information and a large enhancement effect value according to the enhancement effect information from among the plurality of candidate enhancement images as the final enhancement image. That is, the processor 130 may identify an image with a large contrast enhancement effect while maintaining a structure of the image as much as possible from among a plurality of enhancement images as the final enhancement image.

Then, the processor 130 may obtain an output image corresponding to the input image based on the identified final enhancement image (S330). For example, the processor 130 may obtain the output image by applying the tone mapping curve, which was applied to the identified final enhancement image, to the input image.

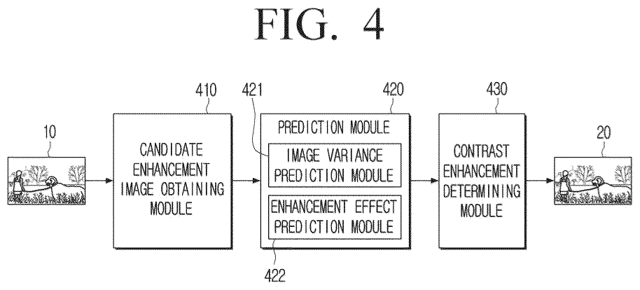

FIG. 4 is a diagram illustrating a configuration of function modules for performing an image processing method according to an embodiment.

Each of the function modules shown in FIG. 4 may be formed with a combination of at least one hardware and/or at least one software.

A candidate enhancement image obtaining module 410 may obtain a plurality of candidate enhancement images obtained by applying each of a plurality of contrast enhancement curves to an input image.

For example, the candidate enhancement image obtaining module 410 may obtain the plurality of candidate enhancement images based on at least one from among an image frame unit, a plurality of image frame units, or a scene unit. For example, the candidate enhancement image obtaining module 410 may obtain an N-number of first candidate enhancement images corresponding to a first image frame by applying each of an N-number of contrast enhancement curves to the first image frame. In addition, the candidate enhancement image obtaining module 410 may obtain an N-number of second candidate enhancement images corresponding to a second image frame by applying each of an N-number of contrast enhancement curves to the second image frame.

A prediction module 420 may include an image variance prediction module 421 and an enhancement effect prediction module 422.

The image variance prediction module 421 may compare each of the plurality of candidate enhancement images with the input image and predict the image variance information (or excessiveness information) corresponding to each of the plurality of candidate enhancement images.

For example, the image variance prediction module 421 may predict image variance information based on at least one from among the image frame unit, the plurality of image frame units, or the scene unit. For example, the image variance prediction module 421 may compare the N-number of first candidate enhancement images with the first image frame and predict first image variance information corresponding to each of the N-number of first candidate enhancement images. In addition, the image variance prediction module 421 may compare the N-number of second candidate enhancement images with the second image frame and predict second image variance information corresponding to each of the N-number of second candidate enhancement images.

The enhancement effect prediction module 422 may predict enhancement effect information corresponding to each of the plurality of candidate enhancement images by comparing each of the plurality of candidate enhancement images with the input image.

For example, the enhancement effect prediction module 422 may predict the enhancement effect information based on at least one from among the image frame unit, the plurality of image frame units, or the scene unit. For example, the enhancement effect prediction module 422 may predict first enhancement effect information corresponding to each of the N-number of first candidate enhancement images based on uniform pixel distribution information of each of the N-number of first candidate enhancement images. In addition, the enhancement effect prediction module 422 may predict second enhancement effect information corresponding to each of the N-number of second candidate enhancement images based on uniform pixel distribution information of each of the N-number of second candidate enhancement images.

A contrast enhancement determining module 430 may determine a final contrast enhancement curve based on a prediction result of the prediction module 420.

For example, the contrast enhancement determining module 430 may determine a final contrast enhancement curve corresponding to the first image frame based on first image variance information corresponding to each of the N-number of first candidate enhancement images and weighted sum information of the first enhancement effect information. In addition, the contrast enhancement determining module 430 may determine a final contrast enhancement curve corresponding to the second image frame based on second image variance information corresponding to each of the N-number of second candidate enhancement images and weighted sum information of the second enhancement effect information.

Although different contrast enhancement curves may be applied for each object (or for each region) according to circumstance, a final contrast enhancement curve may be determined for each object (or each region) with a method similar to the above-described method even in this case. For example, candidate enhancement images applied with different contrast enhancement curves for each object may be obtained, and a final contrast enhancement curve may be determined by obtaining the image variance information and the enhancement effect information for each candidate enhancement image. That is, by applying different combinations of the contrast enhancement curves for each object, respectively, candidate enhancement images corresponding to each combination may be obtained.

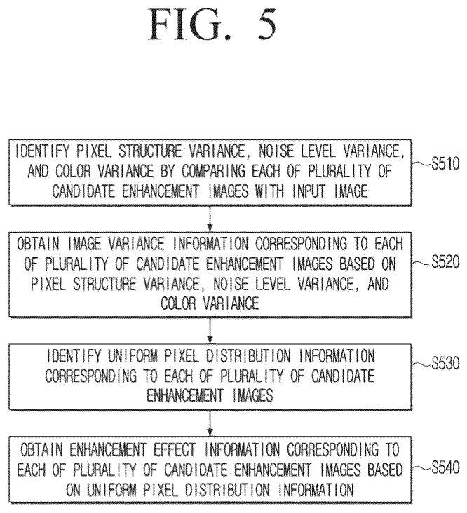

FIG. 5 is a flowchart illustrating a method for predicting image variance information and enhancement effect information according to an embodiment.

According to an embodiment shown in FIG. 5, the processor 130 may compare, in order to obtain image variance information, each of the plurality of candidate enhancement images with an input image, and identify a pixel structure variance, a noise level variance, and a color variance corresponding to each of the plurality of candidate enhancement images (S510). The pixel structure variance, the noise level variance, and the color variance may be examples for obtaining an image variance, but is not necessarily limited thereto. For example, a portion from among the pixel structure variance, the noise level variance, and the color variance may not be used in obtaining the image variance, or other additional variances may be added in obtaining the image variance. In an example, examples used in the image variance may vary according to a type of an image, a frame rate of an original image, and the like.

Then, the processor 130 may obtain the image variance information corresponding to each of the plurality of candidate enhancement images based on the pixel structure variance, the noise level variance, and the color variance (S520). According to an example, the processor 130 may obtain image variance values by applying pre-set weight values corresponding to each of the pixel structure variance, the noise level variance, and the color variance. In this case, the processor 130 may obtain the image variance information by inversely converting the image variance values. For example, the processor 130 may obtain the image variance information by normalizing after inversely converting the image variance values. This is to convert information in an inverse relationship to a same standard in order for the processor 130 to obtain integrated information of image variance information thereafter with enhancement effect information thereafter.

In addition, the processor 130 may identify, in order to obtain the contrast enhancement effect information, the uniform pixel distribution information corresponding to each of the plurality of candidate enhancement images (S530). According to an example, the processor 130 may obtain effect identification values based on histogram information corresponding to each of the plurality of candidate enhancement images.

Then, the processor 130 may obtain the enhancement effect information corresponding to each of the plurality of candidate enhancement images based on the uniform pixel distribution information corresponding to each of the plurality of candidate enhancement images. According to an example, the processor 130 may obtain the enhancement effect information corresponding to each of the plurality of candidate enhancement images by normalizing effect identification values corresponding to each of the plurality of candidate enhancement images.

Then, the processor 130 may identify final identification values corresponding to each of the plurality of candidate enhancement images by applying pre-set weight values to the image variance information and the enhancement effect information, and identify a final enhancement image based on the identified final identification values.

In FIG. 5, although steps S510 and S520 have been shown/described as being performed before steps S530 and S540, because the image variance information and the enhancement effect information are individually obtainable, the embodiment is not limited to an order.

An embodiment of the disclosure will be described in greater detail below with reference to the drawings and Equations.

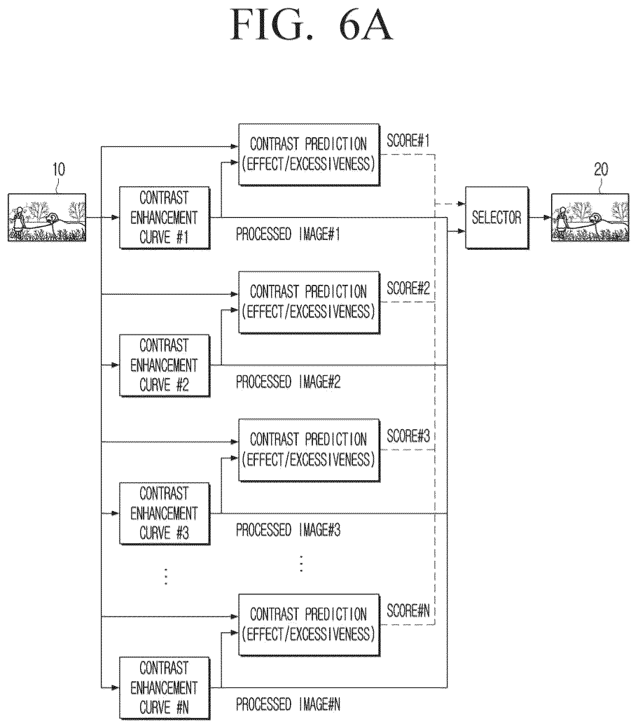

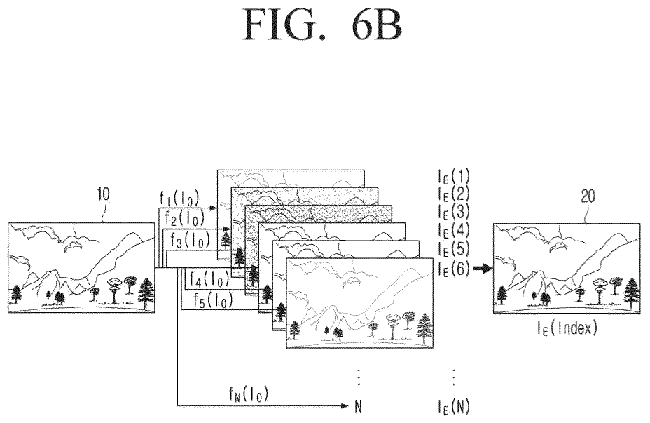

FIG. 6A and FIG. 6B are diagrams illustrating an image processing method according to an embodiment.

According to an example, the processor 130 may obtain an N-number of candidate enhancement images by applying an N-number of contrast enhancement curves with respect to an input image as shown in FIG. 6A. Here, the N-number of contrast enhancement curves may be various curves based on a global curve contrast enhancement, a local curve contrast enhancement, an object unit contrast enhancement, and a combination of these methods.

For example, the processor 130 may obtain candidate enhancement image I_{E}(x) as in Equation 1 below.

$${l}_{E} ( x ) = {f}_{x} ( {l}_{0} ) , x ∈ [ 1 , N ] \qquad [ Equation 1 ]$$

Here, I_{E}(X) may represent the candidate enhancement image, fₓ may represent the contrast enhancement curve, and Iₒ may represent the input image.

For example, as shown in FIG. 6B, candidate enhancement images I_{E}(1), I_{E}(2), . . . I_{E}(N) may be obtained by applying contrast enhancement curves of f₁, f₂, . . . , f_{N} with respect to an input image 10 (Iₒ).

According to an example, the processor 130 may predict an image variance, that is, an excessiveness based on the pixel structure variance (e.g., edge loss and texture variance), the noise level variance, and the color variance according to an excessive contrast ratio enhancement. For example, the excessiveness may be determined as severe as the variance is greater by calculating the pixel structure variance, the noise level variance, and the color variance between the input image and the candidate enhancement images.

According to an example, an image variance prediction value (or an excessiveness prediction value) (OM) may be calculated by calculating the pixel structure variance, the noise level variance, and the color variance between the input image and the candidate enhancement images as in Equation 2.

$$\begin{matrix}OM = Δ ST ⋆ {w}_{S T} + Δ NL ⋆ {w}_{NL} + Δ Color ⋆ {w}_{COLOR} , & {w}_{S T} + {w}_{N L} + {w}_{COLOR} = 1\end{matrix} \qquad [ Equation 2 ]$$

Here, ST may represent the pixel structure variance, ΔNL may represent the noise level variance, and the ΔColor may represent the color variance. w_{ST}, w_{NL} and w_{COLOR} may represent weight values for each term. The w_{ST}, w_{NL} and w_{COLOR} may be determined by learning, or pre-set by a manufacturer, or set/changed by the user.

The pixel structure variance (ΔST) may predict a structural variance of an edge region or a texture region and a contrast enhancement result may be determined as excessive due to the structural variance becoming more severe as values increase. In addition, the noise level variance (ΔNL) may indicate a variance in noise level emphasized by the contrast ratio enhancement, and may mean noise compared to the input image being further emphasized as the variance is greater. In addition, the color variance (ΔColor) may indicate a degree to which color (hue) is distorted by the contrast ratio enhancement and may be determined as a side effect occurring of colors being greatly distorted as the values increase.

The processor 130 may calculate a final image variance prediction value (OM_{final}) by inversely converting and normalizing an image variance prediction value as in Equation 3 below in order to perform an integrated operation with the enhancement effect information. That is, the final image variance prediction value may be determined as not excessive as the variance is greater.

$${OM}_{final} = max ( min ( \frac{{OM}_{max} - OM}{{OM}_{max} - {OM}_{m in}} , 1 ) , 0 ) ⋆ k \qquad [ Equation 3 ]$$

Here, OMₘₐₓ may represent a maximum image variance value, OMₘᵢₙ may represent a minimum image variance value, and k may represent a normalization range.

The processor 130 may obtain the enhancement effect information by calculating a degree of uniform distribution of pixels from the candidate enhancement images. For example, an enhancement effect prediction value may become greater as the pixels are uniformly distributed without being concentrated at a specific pixel value, and this may be determined as having a good contrast enhancement effect.

Equation 4 below may represent an example of a formula for calculating the degree of uniform distribution of pixels using a histogram.

$$\begin{matrix}EM = \frac{1}{TP ⋆ ( TP - 1 )} * {\sum }_{i = 0}^{R - 2} ( {\sum }_{j = i + 1}^{R - 1} Histo ( i ) * Histo ( j ) ⋆ ( j - i ) , & for i , j ∈ [ 0 , R - 1 ]\end{matrix} \qquad [ Equation 4 ]$$

Here, TP may represent a whole number of pixels in an image, and R may represent a representation range of a gray-level (e.g., grayscale of 1024 when representing 10 bit).

In addition, the processor 130 may calculate a final enhancement effect prediction value (EM_{final}) by performing normalizing as in Equation 5 below in order to perform an integrated operation with the image variance prediction value.

$${EM}_{final} = max ( min ( \frac{EM - {EM}_{min}}{{EM}_{max} - {EM}_{min}} , 1 ) , 0 ) ⋆ k \qquad [ Equation 5 ]$$

Here, k may represent the normalization range.

Then, the processor 130 may calculate a final prediction value based on the image variance prediction value and the enhancement effect prediction value. For example, the processor 130 may calculate a final contrast prediction value with respect to the N-number of candidate enhancement images as a score as shown in FIG. 6A.

Equation 6 may represent an example of a formula for calculating the final prediction value.

$$\begin{matrix}Contrast = {w}_{OM} * {OM}_{final} + {w}_{EM} * {EM}_{final} , & {w}_{OM} + {w}_{EM} = 1\end{matrix} \qquad [ Equation 6 ]$$

Here, w_{OM} and w_{EM} represent weight values for the image variance prediction value and the enhancement effect prediction value being differently determined according to a panel characteristic of the display 110, a resolution of an image, an original frame rate of an image, a type of an image, and the like. For example, if the panel has a low brightness and poor contrast ratio characteristics, a weight value (w_{EM}) for the enhancement effect prediction value may be set relatively larger compared to a weight value (w_{OM}) for the image variance prediction value.

Then, the processor 130 may select the largest value, that is, a value with the largest score from among an N-number of final prediction values as an index, and determine the candidate enhancement image corresponding to the relevant index as a final output image I_{E} (Index). Here, the largest value from among the N-number of final prediction values may be a maximum enhancement effect, and the excessiveness associated with the side effect may be a minimum value.

Equation 7 below may represent an example of a formula for determining a final contrast enhancement image.

$$\begin{matrix}Index = arg Max ( Contrast ( x ) ) , & x ∈ [ 1 , N ]\end{matrix} \qquad [ Equation 7 ]$$

For example, as shown in FIG. 6B, a final output image I_{E} (Index) may be selected from among the candidate enhancement images I_{E}(1), I_{E}(2), . . . I_{E}(N).

According to an embodiment, the processor 130 may perform at least a portion from among the above-described image processing operations using a trained artificial intelligence model.

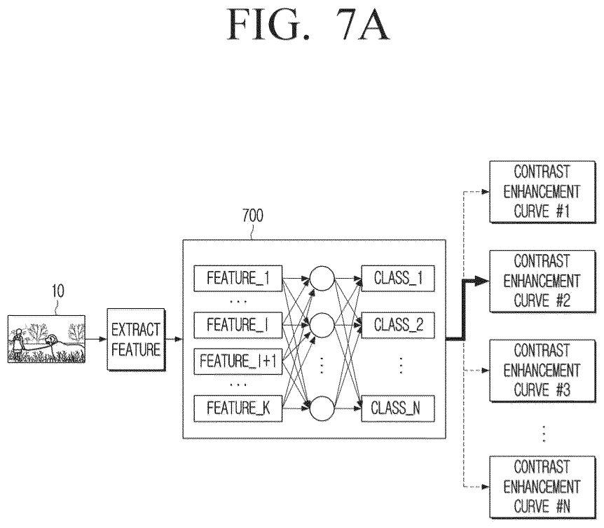

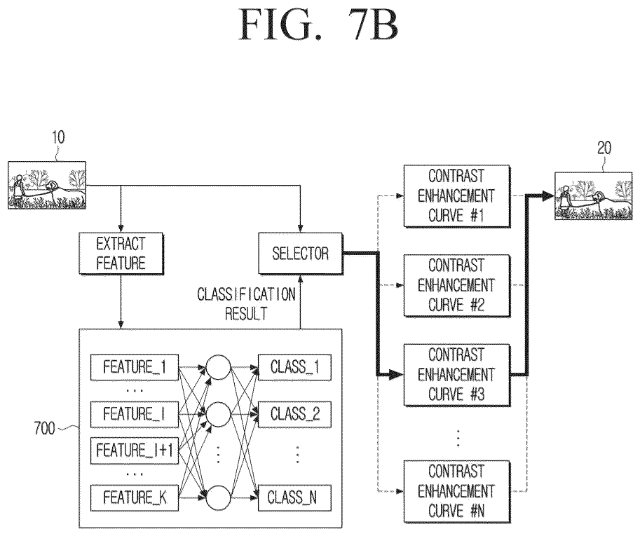

FIG. 7A and FIG. 7B are diagrams illustrating an image processing method which uses a trained artificial intelligence model according to an embodiment.

According to an embodiment, operations of the prediction module 420 and the contrast enhancement determining module 430 shown in FIG. 4 may be learned (trained) through an artificial intelligence model, and the relevant operation may be implemented.

For example, as shown in FIG. 7A, the processor 130 may obtain (or extract) feature information of an image from the image 10, and obtain contrast enhancement curve #2 corresponding to the image 10 by inputting the obtained feature information in a trained first artificial intelligence model 700. That is, the trained first artificial intelligence model 700 may output identification information about contrast enhancement curve #2 corresponding to the image 10 from among the N-number of contrast enhancement curves. Here, the trained first artificial intelligence model 700 may be implemented as a learning based classifier, but is not necessarily limited thereto. According to an example, the feature information of an image may be feature information associated with an image variance and an enhancement effect such as, for example, and without limitation, edge information, texture information, noise information, histogram information, and the like of the image.

According to an example, the trained first artificial intelligence model 700 may be trained to output, based on feature information of an image being input, information about one contrast enhancement curve from among the plurality of contrast enhancement curves based on image variance information and enhancement effect information corresponding to plurality of contrast enhancement curves. When training a first artificial intelligence model 700, Ground Truth may use data obtained according to the methods as described in FIG. 3 to FIG. 6B.

According to an embodiment, the processor 130 may obtain the feature information of the image from the image 10, and may have contrast enhancement curve #2 selected through a selector applied to the image 10 by inputting the obtained feature information in the trained first artificial intelligence model 700. For example, as shown in FIG. 7B, the image 10 is provided to the selector, and an output image 20 may be obtained due to contrast enhancement curve #2 selected through the selector being applied to the image 10. As described, the process of obtaining the output image 20 from the image 10 may be carried out with logic as shown in FIG. 7B.

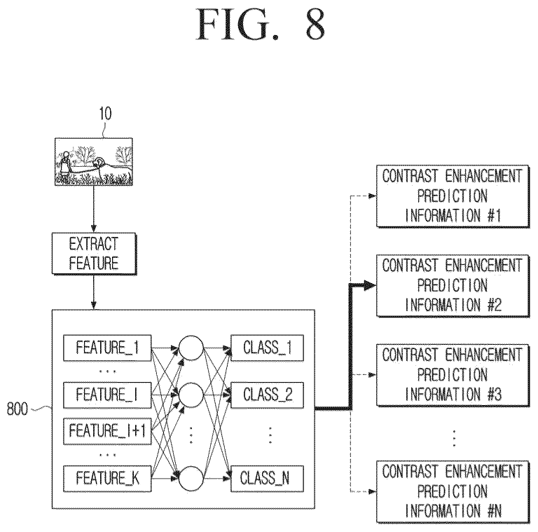

FIG. 8 is a diagram illustrating an image processing method which uses a trained artificial intelligence model according to an embodiment.

According to an embodiment, an operation of the prediction module 420 shown in FIG. 4 may be trained through an artificial intelligence model and a relevant operation may be implemented.

For example, as shown in FIG. 8, the processor 130 may obtain (or extract) feature information of an image from the image 10, and obtain image variance information and enhancement effect information corresponding to a plurality of candidate enhancement images by inputting the obtained feature information in a trained second artificial intelligence model 800. That is, the trained second artificial intelligence model 800 may output image variance information and enhancement effect information corresponding to each of an N-number of contrast enhancement curves. Here, the trained second artificial intelligence model 800 may be implemented as a learning based classifier, but is not necessarily limited thereto. According to an example, the feature information of an image may be feature information associated with the image variance and the enhancement effect such as, for example, and without limitation, edge information, texture information, noise information, histogram information, and the like of the image.

According to an example, the trained second artificial intelligence model 800 may be trained to output, based on feature information of an image being input, the image variance information and the enhancement effect information corresponding to the plurality of candidate enhancement images obtained by applying the plurality of contrast enhancement curves to the image. When training the second artificial intelligence model 800, Ground Truth may use data obtained according to the methods as described in FIG. 3 to FIG. 6B.

In this case, the processor 130 may identify a final enhancement image from among the plurality of candidate enhancement images based on the image variance information and the enhancement effect information corresponding to each of the plurality of candidate enhancement images. That is, the processor 130 may identify a contrast enhancement curve corresponding to the final enhancement image, and process the image 10 based on the identified contrast enhancement curve.

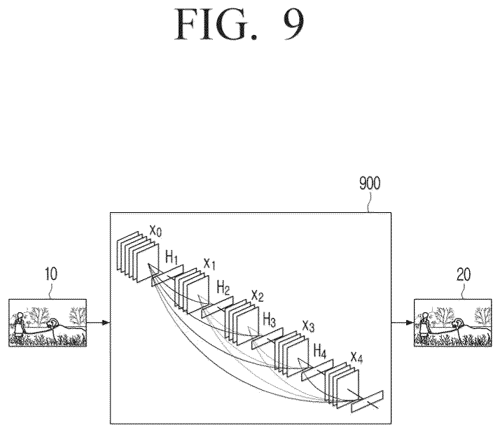

FIG. 9 is a diagram illustrating an image processing method which uses a trained artificial intelligence model according to an embodiment.

According to an embodiment, operations of the candidate enhancement image obtaining module 410, the prediction module 420, and the contrast enhancement determining module 430 as shown in FIG. 4 may be trained through an artificial intelligence model and a relevant operation may be implemented.

For example, as shown in FIG. 9, the processor 130 may obtain the output image 20 by inputting the image 10 in a trained third artificial intelligence model 900. According to an example, the third artificial intelligence model 900 may be implemented as a per-pixel convolutional neural network (CNN) deep learning network, but is not limited thereto.

According to an example, the trained third artificial intelligence model 900 may identify, based on an image being input, image variance information and enhancement effect information corresponding to a plurality of candidate enhancement images obtained by applying a plurality of contrast enhancement curves to the image, and may be trained to output by identifying a final enhancement image from among the plurality of candidate enhancement images based on the identified image variance information and enhancement effect information. When training the third artificial intelligence model 900, Ground Truth may use data obtained according to the methods as described in FIG. 3 to FIG. 6B.

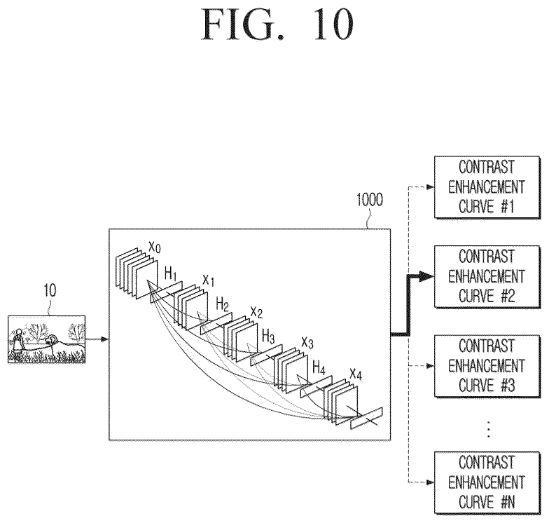

FIG. 10 is a diagram illustrating an image processing method which uses a trained artificial intelligence model according to an embodiment.

According to an embodiment, operations of the candidate enhancement image obtaining module 410, the prediction module 420, and the contrast enhancement determining module 430 as shown in FIG. 4 may be trained through an artificial intelligence model and a relevant operation may be implemented.

For example, as shown in FIG. 10, the processor 130 may obtain contrast enhancement curve #2 corresponding to the input image 10 by inputting the image 10 in a trained fourth artificial intelligence model 1000. According to an example, the fourth artificial intelligence model 1000 may be implemented as the per-pixel convolutional neural network (CNN) deep learning network, but is not limited thereto.

According to an example, the trained fourth artificial intelligence model 1000 may be trained to output, based on an image being input, information about one contrast enhancement curve from among a plurality of contrast enhancement curves based on image variance information and enhancement effect information corresponding to the plurality of contrast enhancement curves. When training the fourth artificial intelligence model 1000, Ground Truth may use data obtained according to the methods as described in FIG. 3 to FIG. 6B.

In this case, the processor 130 may process the image 10 based on the identified contrast enhancement curve (e.g., contrast enhancement curve #2) by using the fourth artificial intelligence model 1000.

According to the various embodiments described above, an optimized contrast ratio enhancement processing may be provided which involves loss of detail in edges and texture being minimized by predicting not only the contrast enhancement effect, but also predicting excessiveness associated with side effects, and change in color being minimal due to noise being less emphasized.

Methods according to the various embodiments of the disclosure described above may be implemented with only a software upgrade, or a hardware upgrade for the electronic device of the related art.

In addition, the various embodiments of the disclosure described above may be performed through an embedded server provided in the electronic device, or performed through an external server of the electronic device.

According to an embodiment of the disclosure, the various embodiments described above may be implemented with software including instructions stored in a machine-readable storage media (e.g., computer). The machine may call a stored instruction from a storage medium, and as a device operable according to the called instruction, may include the electronic device (e.g., electronic device (A)) according to the above-mentioned embodiments. Based on an instruction being executed by the processor, the processor may directly or using other elements under the control of the processor perform a function corresponding to the instruction. The instruction may include a code generated by a compiler or executed by an interpreter. A machine-readable storage medium may be provided in a form of a non-transitory storage medium. Herein, ‘non-transitory’ merely means that the storage medium is tangible and does not include a signal, and the term does not differentiate data being semi-permanently stored or being temporarily stored in the storage medium.

In addition, according to an embodiment of the disclosure, a method according to the various embodiments described above may be provided included a computer program product. The computer program product may be exchanged between a seller and a purchaser as a commodity. The computer program product may be distributed in a form of the machine-readable storage medium (e.g., a compact disc read only memory (CD-ROM)), or distributed online through an application store (e.g., PLAYSTORE™). In the case of online distribution, at least a portion of the computer program product may be stored at least temporarily in the storage medium such as a server of a manufacturer, a server of an application store, or a memory of a relay server, or temporarily generated.

In addition, each of the elements (e.g., a module or a program) according to the various embodiments described above may be configured as a single entity or a plurality of entities, and a portion of sub-elements of the above-mentioned relevant sub-elements may be omitted, or other sub-elements may be further included in the various embodiments. Alternatively or additionally, a portion of the elements (e.g., modules or programs) may be integrated into one entity to perform the same or similar functions performed by each of the relevant elements prior to integration. Operations performed by a module, a program, or another element, in accordance with various embodiments, may be executed sequentially, in a parallel, repetitively, or in a heuristic manner, or at least a portion of the operations may be executed in a different order, omitted or a different operation may be added.

While the disclosure has been illustrated and described with reference to example embodiments thereof, it will be understood that the embodiments are intended to be illustrative, not limiting. It will be understood by those skilled in the art that various changes in form and details may be made therein without departing from the true spirit and full scope of the disclosure, including the appended claims and their equivalents.

What is claimed is:

1. An electronic device comprising:
a display;
memory storing at least one instruction and a plurality of contrast enhancement curves; and
one or more processors operatively connected with the memory,
wherein the at least one instruction, when executed by the one or more processors individually or collectively, causes the electronic device to:
obtain a plurality of candidate enhancement images by applying each contrast enhancement curve of the plurality of contrast enhancement curves to an input image;
compare the plurality of candidate enhancement images with the input image and identify image variance information and enhancement effect information corresponding to each candidate enhancement image of the plurality of candidate enhancement images;
identify a final enhancement image from among the plurality of candidate enhancement images based on the image variance information and the enhancement effect information corresponding to each candidate image; and
display, via the display, an output image corresponding to the input image based on the identified final enhancement image.

2. The electronic device of claim 1, wherein the at least one instruction, when executed by the one or more processors individually or collectively, causes the electronic device to:
identify a pixel structure variance, a noise level variance, and a color variance corresponding to each candidate enhancement image by comparing each candidate enhancement image with the input image; and
obtain the image variance information corresponding to each candidate enhancement image based on the pixel structure variance, the noise level variance, and the color variance.

3. The electronic device of claim 2, wherein the at least one instruction, when executed by the one or more processors individually or collectively, causes the electronic device to:
identify uniform pixel distribution information corresponding to each candidate enhancement image; and
obtain the enhancement effect information corresponding to each candidate enhancement image based on the uniform pixel distribution information.

4. The electronic device of claim 3, wherein the at least one instruction, when executed by the one or more processors individually or collectively, causes the electronic device to:
obtain image variance values by applying pre-set weight values corresponding to each of the pixel structure variance, the noise level variance, and the color variance; and
obtain the image variance information by normalizing after inversely converting the image variance values.

5. The electronic device of claim 4, wherein the at least one instruction, when executed by the one or more processors individually or collectively, causes the electronic device to:
obtain effect identification values based on histogram information corresponding to each candidate enhancement image;
obtain the enhancement effect information by normalizing the effect identification values;
identify final identification values corresponding to each candidate enhancement image by applying the pre-set weight values to the image variance information and the enhancement effect information; and
identify the final enhancement image based on the identified final identification values.

6. The electronic device of claim 5, wherein the at least one instruction, when executed by the one or more processors causes individually or collectively, the electronic device to display the output image through the display, and
wherein the pre-set weight values are identified differently according to a panel characteristic of the display.

7. The electronic device of claim 1, wherein the at least one instruction, when executed by the one or more processors individually or collectively, causes the electronic device to identify, as the final enhancement image, an image with a small image variance value according to the image variance information and a large enhancement effect value according to the enhancement effect information from among the plurality of candidate enhancement images.

8. The electronic device of claim 1, wherein the at least one instruction, when executed by the one or more processors causes the electronic device to:
obtain feature information from the input image;
obtain the contrast enhancement curve corresponding to the input image from among the plurality of contrast enhancement curves by inputting the obtained feature information in a trained first artificial intelligence model; and
obtain the output image by processing the input image based on the obtained contrast enhancement curve,
wherein the trained first artificial intelligence model is trained to output, based on the feature information of an image being input, information about one contrast enhancement curve from among the plurality of contrast enhancement curves based on the image variance information and the enhancement effect information corresponding to the plurality of contrast enhancement curves of the image.

9. The electronic device of claim 1, wherein the at least one instruction, when executed by the one or more processors causes the electronic device to:
obtain feature information from the input image;
obtain the image variance information and the enhancement effect information corresponding to the plurality of candidate enhancement images by inputting the obtained feature information in a trained second artificial intelligence model; and
identify the final enhancement image from among the plurality of candidate enhancement images based on the image variance information and the enhancement effect information corresponding to each candidate enhancement image,
wherein the trained second artificial intelligence model is trained to output, based on the feature information of an image being input, the image variance information and the enhancement effect information corresponding to the plurality of candidate enhancement images obtained by applying the plurality of contrast enhancement curves to the image.

10. The electronic device of claim 1, wherein the at least one instruction, when executed by the one or more processors individually or collectively, causes the electronic device to obtain the output image by inputting the input image in a trained third artificial intelligence model,
wherein the trained third artificial intelligence model is trained to identify, based on an image being input, the image variance information and the enhancement effect information corresponding to the plurality of candidate enhancement images obtained by applying the plurality of contrast enhancement curves to the image, and output by identifying the final enhancement image from among the plurality of candidate enhancement images based on the identified image variance information and the identified enhancement effect information.

11. An image processing method of an electronic device, the image processing method comprising:
obtaining a plurality of candidate enhancement images by applying each contrast enhancement curve of a plurality of contrast enhancement curves to an input image;
comparing the plurality of candidate enhancement images with the input image and identifying image variance information and enhancement effect information corresponding to each candidate enhancement image of the plurality of candidate enhancement images;
identifying a final enhancement image from among the plurality of candidate enhancement images based on the image variance information and the enhancement effect information corresponding to each candidate enhancement image; and
displaying an output image corresponding to the input image based on the identified final enhancement image.

12. The image processing method of claim 11, wherein the identifying the image variance information and the enhancement effect information comprises:
identifying a pixel structure variance, a noise level variance, and a color variance corresponding to each candidate enhancement image by comparing each candidate enhancement image with the input image; and
obtaining the image variance information corresponding to each candidate enhancement image based on the pixel structure variance, the noise level variance, and the color variance.

13. The image processing method of claim 12, wherein the identifying the image variance information and the enhancement effect information further comprises:
identifying uniform pixel distribution information corresponding to each candidate enhancement image; and
obtaining the enhancement effect information corresponding to each candidate enhancement image based on the uniform pixel distribution information.

14. The image processing method of claim 13, wherein the obtaining the image variance information comprises:
obtaining image variance values by applying pre-set weight values corresponding to each of the pixel structure variance, the noise level variance, and the color variance; and
obtaining the image variance information by normalizing after inversely converting the image variance values.

15. The image processing method of claim 14, the method further comprising:
obtaining effect identification values based on histogram information corresponding to each candidate enhancement image;
obtaining the enhancement effect information by normalizing the effect identification values;
identifying final identification values corresponding to each candidate enhancement image by applying the pre-set weight values to the image variance information and the enhancement effect information; and
identifying the final enhancement image based on the identified final identification values.

16. The image processing method of claim 11, the method further comprising:
identifying, as the final enhancement image, an image with a small image variance value according to the image variance information and a large enhancement effect value according to the enhancement effect information from among the plurality of candidate enhancement images.

17. The image processing method of claim 11, the method further comprising:
obtaining feature information from the input image;
obtaining the contrast enhancement curve corresponding to the input image from among the plurality of contrast enhancement curves by inputting the obtained feature information in a trained first artificial intelligence model; and
obtaining the output image by processing the input image based on the obtained contrast enhancement curve,
wherein the trained first artificial intelligence model is trained to output, based on the feature information of an image being input, information about one contrast enhancement curve from among the plurality of contrast enhancement curves based on the image variance information and the enhancement effect information corresponding to the plurality of contrast enhancement curves of the image.

18. The image processing method of claim 11, the method further comprising:
obtaining feature information from the input image;
obtaining the image variance information and the enhancement effect information corresponding to the plurality of candidate enhancement images by inputting the obtained feature information in a trained second artificial intelligence model; and
identifying the final enhancement image from among the plurality of candidate enhancement images based on the image variance information and the enhancement effect information corresponding to each candidate enhancement image,
wherein the trained second artificial intelligence model is trained to output, based on the feature information of an image being input, the image variance information and the enhancement effect information corresponding to the plurality of candidate enhancement images obtained by applying the plurality of contrast enhancement curves to the image.

19. The image processing method of claim 11, the method further comprising:
obtaining the output image by inputting the input image in a trained third artificial intelligence model,
wherein the trained third artificial intelligence model is trained to identify, based on an image being input, the image variance information and the enhancement effect information corresponding to the plurality of candidate enhancement images obtained by applying the plurality of contrast enhancement curves to the image, and output by identifying the final enhancement image from among the plurality of candidate enhancement images based on the identified image variance information and the identified enhancement effect information.

20. A non-transitory computer-readable medium which stores computer instructions for an electronic device to perform an operation when executed by one or more processors of the electronic device, the operation comprising:
obtaining a plurality of candidate enhancement images by applying each contrast enhancement curve of a plurality of contrast enhancement curves to an input image;
comparing the plurality of candidate enhancement images with the input image and identifying image variance information and enhancement effect information corresponding to each candidate enhancement image of the plurality of candidate enhancement images;
identifying a final enhancement image from among the plurality of candidate enhancement images based on the image variance information and the enhancement effect information corresponding to each candidate enhancement image; and
displaying an output image corresponding to the input image based on the identified final enhancement image.
